(19) United States
(12) Patent Application Publication
(10) Pub. No.: US 2026/0067233 A1
(43) Pub. Date: Mar. 5, 2026

(54) BANDWITH-AWARE WEIGHTED ARBITRATION FOR A RECONFIGURABLE DATA PROCESSOR

(71) Applicant: SambaNova Systems, Inc., Palo Alto, CA (US)

(72) Inventors: Hakan Zeffer, Enskede (SE); Oliver Bowen, Palo Alto, CA (US); Jeremy MERVAK, Palo Alto, CA (US); Per LIDEN, Palo Alto, CA (US)

(73) Assignee: SambaNova Systems, Inc., Palo Alto, CA (US)

(21) Appl. No.: 19/091,281

(22) Filed: Mar. 26, 2025

Related U.S. Application Data
(60) Provisional application No. 63/691,230, filed on Sep. 5, 2024.

(51) Int. Cl. H04L 49/112; H04L 47/2483; H04L 49/253

(52) U.S. Cl. CPC H04L 49/112; H04L 47/2483; H04L 49/254

(57) ABSTRACT

A system comprises a reconfigurable processor including a network of a plurality of switches; an array of configurable units connected to the network and configured to execute an application. Each switch includes a plurality of input and output ports. A first input port of a switch is coupled to a first memory having a first bandwidth and a second input port of the switch is coupled to a memory having a second bandwidth. The switch is coupled to transfer a first data from the first memory via the first input port and a second data from the second memory via the second input to a common output port. The system includes an arbiter that selects the first input port and the second input port to transfer data to the common output port for a time proportional to the first bandwidth and the second bandwidth respectively.

### RELATED APPLICATION(S) AND DOCUMENTS

This application claims the benefit of (priority to) U.S. Provisional Application 63/691,230 filed on Sep. 5, 2024, entitled “BANDWIDTH-AWARE WEIGHTED ARBITRATION FOR A RECONFIGURABLE DATA PROCESSOR” (Attorney Docket No. SBNV1197USP01).

This application is related to the following papers and commonly owned applications:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language And Compiler For Application Accelerators,” Proceedings Of The 39th ACM SIGPLAN Conference On Programming Language Design And Embodiment (PLDI), Proceedings of the 43rd International Symposium on Computer Architecture, 2018;
U.S. Nonprovisional patent application Ser. No. 16/239,252, filed Jan. 3, 2019, now U.S. Pat. No. 10,698,853, entitled “VIRTUALIZATION OF A RECONFIGURABLE DATA PROCESSOR;”
U.S. Nonprovisional patent application Ser. No. 16/197,826, filed Nov. 21, 2018, now U.S. Pat. No. 10,831,507, entitled “CONFIGURATION LOAD OF A RECONFIGURABLE DATA PROCESSOR;”
U.S. Nonprovisional patent application Ser. No. 16/407,675, filed May 9, 2019, now U.S. Pat. No. 11,386,038, entitled “CONTROL FLOW BARRIER AND RECONFIGURABLE DATA PROCESSOR;”
U.S. Nonprovisional patent application Ser. No. 16/890,841, filed Jun. 2, 2020, entitled “ANTI-CONGESTION FLOW CONTROL FOR RECONFIGURABLE PROCESSORS;”
U.S. Nonprovisional patent application Ser. No. 16/922,975, filed Jul. 7, 2020, entitled “RUNTIME VIRTUALIZATION OF RECONFIGURABLE DATA FLOW RESOURCES;”
U.S. Provisional Patent Application No. 63/236,218, filed Aug. 23, 2021, entitled “SWITCH FOR A RECONFIGURABLE DATAFLOW PROCESSOR.”
U.S. Nonprovisional patent application Ser. No. 18/107,690, filed Feb. 9, 2023, entitled “Two-level arbitration in a reconfigurable processor;”

All of the related application(s) and documents listed above are hereby incorporated by reference herein for all purposes.

### TECHNICAL FIELD

The present subject matter relates to bandwidth-aware weighted arbitration in a reconfigurable data processor.

### BACKGROUND

The technology disclosed relates to bandwidth-aware weighted arbitration in a reconfigurable data processor.

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Systems with reconfigurable processors which execute dataflow graphs include a compiler which translates and synthesizes a machine learning model of the dataflow graphs onto arrays of reconfigurable units. For performing various operations related to the dataflow graphs, reconfigurable processors can include various agents connected on an internal network to facilitate traffic to reconfigurable units. Any such network needs to provide an equality of service to all agents in a fair manner for increasing overall performance of such systems.

### BRIEF DESCRIPTION OF THE DRAWINGS

The technology will be described with reference to the drawings, in which:

FIG. 1 is a system diagram illustrating a system including a host, a memory, and a coarse-grained reconfigurable (CGR) processor.

FIG. 2 illustrates an example of a computer, including an input device, a processor, a storage device, and an output device.

FIG. 2A illustrates example details of a CGR architecture including a top-level network (TLN) and two CGR arrays.

FIG. 3 illustrates an example CGR array, including an array of configurable nodes in an array-level network (ALN).

FIG. 4 illustrates an example block diagram of a TLN, according to an embodiment of the present disclosure.

FIG. 5 illustrates an example of a mesh network included in a TLN, according to an embodiment of the present disclosure.

FIG. 6 illustrates an example of a single switch included in a TLN, according to an embodiment of the present disclosure.

FIG. 7 illustrates an example block diagram of an input port of a switch included in a TLN, according to an embodiment of the present disclosure.

FIG. 8 illustrates an example block diagram of an output port of a switch included in a TLN, according to an embodiment of the present disclosure.

FIG. 9 illustrates an example block diagram of bandwidth-aware weighted round-robin arbitration for active flows with different weights.

FIG. 10 illustrates another example implementation of bandwidth-aware weighted round-robin arbitration for active flows with different weights.

FIG. 11 illustrates an example of active flows in the TLN shown in the FIG. 4, according to an embodiment of the present disclosure.

FIG. 12 illustrates an example implementation of bandwidth-aware weighted round-robin for active flows shown in FIG. 11, according to an embodiment of the present disclosure.

FIG. 13 illustrates an example flow diagram for an example method for a bandwidth-aware weighted round-robin arbitration, according to an embodiment of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures and components have been described at a relatively high level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Some descriptive terms and phrases are presented in the following paragraphs for clarity.

The technology disclosed relates to a bandwidth-aware weighted arbitration in a reconfigurable data processor.

More specifically, embodiments of the present disclosure describe a bandwidth-aware weighted arbitration scheme for managing active data flows in a top-level network (TLN) such that the data flows get an equality of service based on the bandwidth of the memories that they are coupled to. A CGR processor includes arrays of reconfigurable units arranged as “tiles.” Each tile may also be referred to as a “minimum compute/computing unit.” In order to execute a data graph, a CGR processor has to perform a range of graph-related operations (e.g., running a graph, tuning the hyper-parameters of a graph, updating input/output endpoints of a graph, etc.)

Reconfigurable processors often include mesh networks for interconnections between arrays of reconfigurable units and communication agents, switches, or nodes. Such mesh networks are used for exchanging data with a host or memory. An array of reconfigurable units may be implemented as an array-level network (ALN) and the communication agents/switches may be implemented as a top-level network. In such scenarios, equality of service (EoS) refers to the ability of a network to service all agents in a globally fair manner. In a mesh network each node, switch, or agent services incoming and outgoing data traffic to adjacent switches in a sequential manner, which can lead to a scenario in which each switch only sees a local view of its ports for incoming traffic. From a global perspective, some ports of a switch end up servicing more nodes than others which results in an unequal traffic service.

The present disclosure discloses a bandwidth-aware weighted round-robin arbitration (BW-aware RR Arbitration Engine or arbiter) which is operatively coupled to assign weights to the incoming traffic flows based on their required BW and further determine an input port's weight based on the weights of the flows. In one example, for any one port all the active input flows' bandwidth weights are added together to find out a total weight for that port. Furthermore, the arbiter is operatively coupled to arbitrate the flows to a particular output such as a port or a node in the mesh network, for a time proportional to its total weight.

In one example, finding out bandwidths of different flows and assigning a bandwidth weight per flow can be implemented using source identifiers which convey information about the required bandwidths. There can be a bandwidth requirement lookup table for looking up a configurable flow weight. In another example, there can be meta-data in the traffic itself (data packet(s)) which can carry bandwidth requirements. This information may be used directly or can be used as an index for looking up a configurable weight table. For example, if a switch has 2 input ports and 1 output port. Then suppose we have two types of traffic, an HBM flow at 64 GBps and a LBM flow at 16 GBps, then according to one example, the disclosed arbiter is coupled to give the HBM flow a weight of 4 (since the required bandwidth is 4 times that of LBM (64/16)) and the LBM flow a weight of 1 (16/16). Source IDs can be used to identify whether a flow originates from HBM or LBM, and select the correct weight, 4 or 1). Those skilled in the art may understand that if a first input port (A) has a single LBM flow (1×LBM) and a single HBM flow (1×HBM) passing through it, then the input port A total bandwidth equals 64+16=80. Similarly, if a second input port B has three LBM flows (3×LBM) passing through it the input port B's total bandwidth equals 16+16+16=48. In one example, the weights are calculated as follows:
a. Input port A gets two input weights→4 (HBM)+1 (LBM)=5
b. Input port B gets three input weights→1 (LBM)+1 (LBM)+1 (LBM)=3 Input port A gets 5/(5+3)=62.5% (=ideal 62.5%) utilization of the output port. More details about such an example will be described in the paragraphs below.

It may be understood by those skilled in the art that arbitration is only needed when there is contention i.e., when multiple input ports are waiting to send packets to a particular output port in the same cycle. If a single port wants to send packets to a particular output port, then arbitration is not needed, and the packets can be sent immediately. Additionally, whenever arbitration is needed, arbiters need to be activated. Data transfer between switches, nodes, and Shims is facilitated by availability of credits, specifically “hop credits,” meaning that data is transferred from a source switch/node/shim to an adjacent destination switch/node if there are any credits available in the destination switch. In one example, another requirement for an arbiter to become active is that packets have to be ready to go in the input port buffers. More details about such a credit-based control and logic are explained a related U.S. Nonprovisional patent application Ser. No. 18/107,690, filed Feb. 9, 2023, entitled “Two-level arbitration in a reconfigurable processor.”

Traditional compilers translate human-readable computer source code into machine code that can be executed on a Von Neumann computer architecture. In this architecture, a processor serially executes instructions in one or more threads of software code. The architecture is static, and the compiler does not determine how execution of the instructions is pipelined, or which processor or memory takes care of which thread. Thread execution is asynchronous, and safe exchange of data between parallel threads is not supported.

High-level programs for machine learning (ML) and artificial intelligence (AI) may require massively parallel computations, where many parallel and interdependent threads (meta-pipelines) exchange data. Such programs are ill-suited for execution on Von Neumann computers. They require architectures that are optimized for parallel processing, such as coarse-grained reconfigurable architectures (CGRAs) or graphic processing units (GPUs). The ascent of ML, AI, and massively parallel architectures places new requirements on compilers, including how computation graphs, and in particular dataflow graphs, are pipelined, which operations are assigned to which compute units, how data is routed between various compute units and memory, and how synchronization is controlled particularly when a dataflow graph includes one or more nested loops, whose execution time varies dependent on the data being processed.

As used herein, the phrase “one of” should be interpreted to mean exactly one of the listed items. For example, the phrase “one of A, B, and C” should be interpreted to mean any of: only A, only B, or only C.

As used herein, the phrases at least one of and one or more should be interpreted to mean one or more items. For example, the phrase “at least one of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object merely refers to different instances or classes of the object and does not imply any ranking or sequence.

The following terms or acronyms used herein are defined at least in part as follows:

AGCU—address generator (AG) and coalescing unit (CU).

AI—artificial intelligence.

AIR—arithmetic or algebraic intermediate representation.

ALN—array-level network.

Buffer—an intermediate storage of data.

CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable. This term may be used alternatively with “RDU (reconfigurable dataflow unit.)”

CGRA—coarse-grained reconfigurable architecture. A data processor architecture that includes one or more arrays (CGR arrays) of CGR units.

Compiler—a translator that processes statements written in a programming language to machine language instructions for a computer processor. A compiler may include multiple stages to operate in multiple steps. Each stage may create or update an intermediate representation (IR) of the translated statements.

Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.

CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.

CU—coalescing unit.

Data Flow Graph—a computation graph that includes one or more loops that may be nested, and wherein nodes can send messages to nodes in earlier layers to control the dataflow between the layers.

Datapath—a collection of functional units that perform data processing operations. The functional units may include memory, multiplexers, ALUs, SIMDs, multipliers, registers, buses, etc.

Data sink—a unit or an agent that accepts data.

Data source—a unit or an agent that send/provides data.

FCMU—fused compute and memory unit—a circuit that includes both a memory unit and a compute unit.

Graph—a collection of nodes connected by edges. Nodes may represent various kinds of items or operations, dependent on the type of graph. Edges may represent relationships, directions, dependencies, etc.

IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in industry, produced by the same supply chains, and for the average user often indistinguishable from monolithic circuits.

A logical CGR array or logical CGR unit—a CGR array or a CGR unit that is physically realizable, but that may not have been assigned to a physical CGR array or to a physical CGR unit on an IC.

ML—machine learning.

PCU—pattern compute unit—a compute unit that can be configured to perform one or more operations.

PEF—processor-executable format—a file format suitable for configuring a configurable data processor.

Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a meta-pipeline at the graph execution level to enable correct timing of node-level operations of the configured graph. Gate-level pipelines are usually hard wired and unchangeable, whereas meta-pipelines are configured at the CGR processor, CGR array level, and/or GCR unit level.

Pipeline Stages—a pipeline is divided into stages that are coupled with one another to form a pipe topology.

PMU—pattern memory unit—a memory unit that can locally store data.

PNR—place and route—the assignment of logical CGR units and associated processing/operations to physical CGR units in an array, and the configuration of communication paths between the physical CGR units.

RAIL—reconfigurable dataflow unit (RDU) abstract intermediate language.

CGR Array—an array of CGR units, coupled with each other through an array-level network (ALN), and coupled with external elements via a top-level network (TLN). A CGR array can physically implement the nodes and edges of a dataflow graph and is sometimes referred to as a reconfigurable dataflow unit (RDU).

SIMD—single-instruction multiple-data—an arithmetic logic unit (ALU) that simultaneously performs a single programmable operation on multiple data elements delivering multiple output results.

TLIR—template library intermediate representation.

TLN—top-level network.

HBM—High Bandwidth Memory

LBM—Low Bandwidth Memory

The architecture, configurability and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

Translation of high-level programs to executable bit files is performed by a compiler. While traditional compilers sequentially map operations to processor instructions, typically without regard to pipeline utilization and duration (a task usually handled by the hardware), an array of CGR units requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

In dataflow processors with reconfigurable architectures, a pipeline of computational stages can be formed in the array of reconfigurable units to execute dataflow graphs. Since various computational stages can have various latencies, efficiently managing the pipeline, especially when it comes to providing the final output of the pipeline, can be challenging.

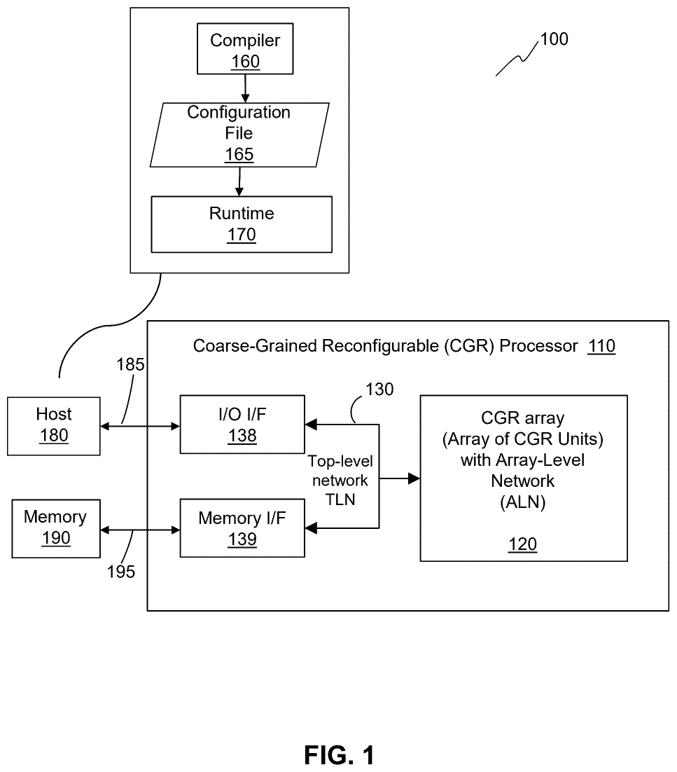

FIG. 1 illustrates an example system 100 including a CGR processor 110, a host 180, and a memory 190. CGR processor 110 has a coarse-grained reconfigurable architecture (CGRA) and includes an array of CGR units 120 such as a CGR array. CGR processor 110 further includes an IO interface 138, and a memory interface 139. The array of CGR units 120 is coupled with IO interface 138 and memory interface 139 via databus 130 which may be part of a top-level network (TLN). Host 180 communicates with IO interface 138 via system databus 185, and memory interface 139 communicates with memory 190 via memory bus 195. Array of CGR units 120 may further include compute units and memory units that are connected with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 110. In some implementations, CGR processor 110 may include one or more ICs. In other implementations, a single IC may span multiple CGR processors. In further implementations, CGR processor 110 may include one or more units of the array of CGR units 120.

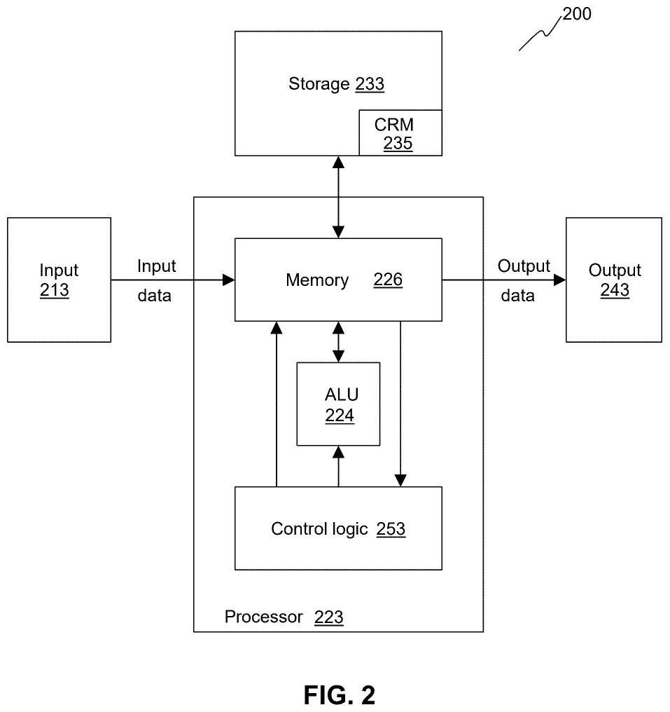

Host 180 may be or include a computer such as further described with reference to FIG. 2. Host 180 runs runtime 170, as further referenced herein, and may also be used to run computer programs, such as the compiler 160. In some implementations, the compiler may run on a computer that is similar to the computer described with reference to FIG. 2 but separate from host 180.

CGR processor 110 may accomplish computational tasks by executing a configuration file 165. For the purposes of this description, a configuration file corresponds to a dataflow graph, or a translation of a dataflow graph, and may further include initialization data. A compiler 160 compiles the high-level program to provide the configuration file 165. In some implementations described herein, a CGR array is configured by programming one or more configuration stores with all or parts of the configuration file 165. A single configuration store may be at the level of the CGR processor or the CGR array, or a CGR unit may include an individual configuration store. The configuration file may include configuration data for the CGR array and CGR units in the CGR array and link the computation graph to the CGR array. Execution of the configuration file 165 by CGR processor 110 causes the CGR array(s) to implement the user algorithms and functions in the dataflow graph.

CGR processor 110 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 213, a processor 223, a storage device 233, and an output device 243. Although the example computer 200 is drawn with a single processor, other implementations may have multiple processors. Input device 213 may comprise a mouse, a keyboard, a sensor, an input port (for example, a universal serial bus (USB) port), and any other input device known in the art. Output device 243 may comprise a monitor, printer, and any other output device known in the art. Furthermore, part or all of input device 213 and output device 243 may be combined in a network interface, such as a Peripheral Component Interconnect Express (PCIe) interface suitable for communicating with CGR processor 110. Input device 213 is coupled with processor 223 to provide input data, which in an implementation may store in memory 226. Processor 223 is coupled with output device 243 to provide output data from memory 226 to output device 243. Processor 223 further includes control logic 253, operable to control memory 226 and arithmetic and logic unit (ALU) 224, and to receive program and configuration data from memory 226. Control logic 253 further controls exchange of data between memory 226 and storage device 233. Memory 226 typically comprises memory with fast access, such as static random-access memory (SRAM), whereas storage device 233 typically comprises memory with slow access, such as dynamic random-access memory (DRAM), flash memory, magnetic disks, optical disks, and any other memory type known in the art. At least a part of the memory in storage device 233 includes a non-transitory computer-readable medium (CRM 235), such as used for storing computer programs.

FIG. 2A illustrates example details of a CGR architecture 270 including a top-level network (TLN 230) and two CGR arrays (CGR array1 280 and CGR array2 290). The CGR arrays may also be referred to as “tiles.” As such, the CGR array1 280 may be referred to as “tile1 280” and the CGR array2 290 may be referred to as “tile2 290.”

A CGR array comprises an array of CGR units (e.g., PMUs, PCUs, FCMUs) coupled via an array-level network (ALN), e.g., a bus system. The ALN is coupled with the TLN 230 through several AGCUs, and consequently with I/O interface 238 (or any number of interfaces) and memory interfaces including a low bandwidth memory (LBM) interface 239 and a high bandwidth memory interface (HBM) 241. Other implementations may use different bus or communication architectures.

Circuits on the TLN in this example include one or more external I/O interfaces, including I/O interface 238 and memory interfaces including the LBM interface 239 and the HBM interface 241. The interfaces to external devices include circuits for routing data among circuits coupled with the TLN and external devices, such as high-capacity memory, host processors, other CGR processors, FPGA devices, and so on, that are coupled with the interfaces.

Each depicted CGR array has four AGCUs (e.g., MAGCU1, AGCU12, AGCU13, and AGCU14 in CGR array 280). The AGCUs interface the TLN to the ALNs and route data from the TLN to the ALN or vice versa.

One of the AGCUs in each CGR array in this example is configured to be a master AGCU (MAGCU), which includes an array configuration load/unload controller for the CGR array. The MAGCU1 includes a configuration load/unload controller for the CGR array1 280, and MAGCU2 includes a configuration load/unload controller for the CGR array2 290. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 271, switch 272, switch 273, switch 274, switch 275, and switch 276) coupled with each other as well as with other circuits on the TLN, including the AGCUs, and external I/O interface 238. The TLN includes links (e.g., L11, L12, L21, L22) coupling the top-level switches. Data may travel in packets between the top-level switches on the links, and from the switches to the circuits on the network coupled with the switches. For example, the switches 271 and 272 are coupled by the link L11, the switches 274 and 275 are coupled by the link L12, the switches 271 and 274 are coupled by the link L13, and the switches 272 and 273 are coupled by the link L21. The links can include one or more buses and supporting control lines, including for example a chunk-wide bus (vector bus). For example, the top-level network can include data, request and response channels operable in coordination for transfer of data in any manner known in the art.

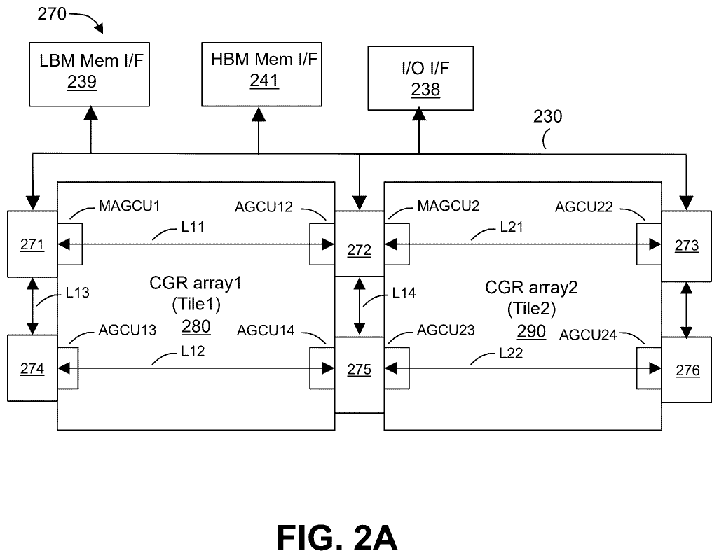

FIG. 3 illustrates an example CGR array 300, including an array of CGR units in an ALN. CGR array 300 may include several types of CGR unit 301, such as FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017 Jun. 24-28, 2017, Toronto, ON, Canada. Each of the CGR units may include a configuration store 302 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 301 comprises an FCMU. In other implementations, the array comprises both PMUs and PCUs, or memory units and compute units, arranged in a checkerboard pattern. In yet other implementations, CGR units may be arranged in different patterns. The ALN includes switch units 303 (S), and AGCUs (each including two address generators 305 (AG) and a shared coalescing unit 304 (CU)). Switch units 303 are connected among themselves via interconnects 321 and to a CGR unit 301 with interconnects 322. Switch units 303 may be coupled with the address generators 305 via interconnects 320. In some implementations, communication channels can be configured as end-to-end connections, and switch units 303 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 321 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 301 may have four ports (as drawn) to interface with switch units 303, or any other number of ports suitable for an ALN. Each port may be suitable for receiving and transmitting data, or a port may be suitable for only receiving or only transmitting data.

A switch unit, as shown in the example of FIG. 3, may have eight interfaces. The North, South, East and West interfaces of a switch unit may be used for links between switch units using interconnects 321. The Northeast, Southeast, Northwest and Southwest interfaces of a switch unit may each be used to make a link with an FCMU, PCU or PMU instance using one of the interconnects 322. Two switch units in each CGR array quadrant have links to an AGCU using interconnects 320. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 300, and any number of other CGR arrays coupled with CGR array 300.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

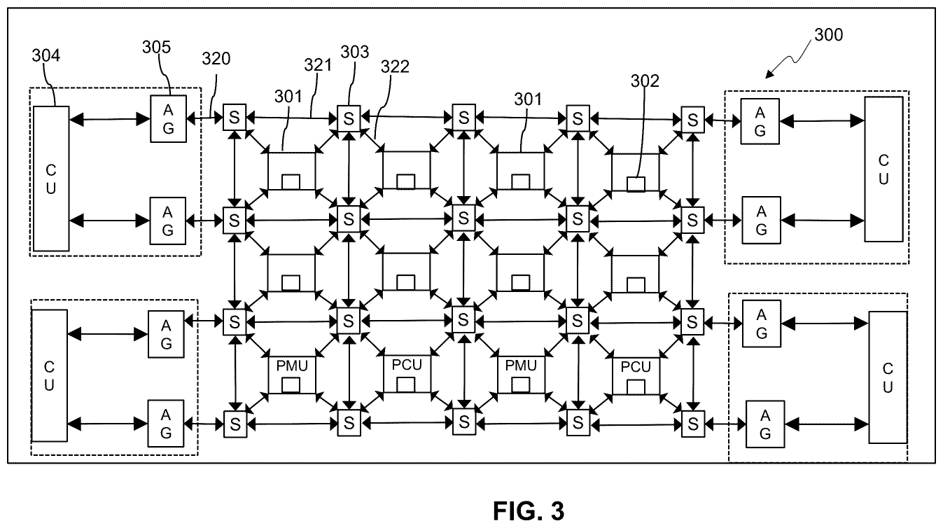

FIG. 4 illustrates an example diagram of a TLN 400 including a plurality of TLN switches operatively coupled to communicate with the LBM/HBM interfaces and the AGCUs.

The LBM can include DDRs and the HBMs can include HBMs having higher bandwidths than typical DDRs.

Specifically, the TLN 400 on the left side includes AGCUs AGCU8 418 to AGCU15 432, AGCU0 402 to AGCU7 416, I/O interfaces (collectively shown as I/O INFC 150 for LBM/HBM), more specifically including LShims (LShim0 444, LShim1 450) Hshims (HShim0 446, Hshim1 448) and TLN switches S0 401, S1 403, S2 405, S3 407, S4 409, S5 411, S6 413, S7 415 arranged in a column 447 and coupled to facilitate communication among the AGCUs and the LShims and HShims.

Furthermore, the TLN 400 on the right side includes I/O interfaces 452, 454, 456, 458, 460, 462, 464, and 466 for LBMs or HBMs (collectively shown as I/O INFC 150 for LBM/HBM), and TLN switches S8 417, S9 419, S10 421, S11 423, S12 425, S13 427, S14 429, S15 431 arranged in a column 457 and coupled to facilitate communication among the AGCUs and the LShims and HShims.

The TLN 400 shows a single lane of switches on either side. In other examples, there can be multiple lanes of TLN switches on either side. One such implementation is described in a related patent U.S. Nonprovisional patent application Ser. No. 18/107,690, filed Feb. 9, 2023, entitled “Two-level arbitration in a reconfigurable processor”. As explained in the above-mentioned related application, each switch includes four nodes. As will be explained in more detail with respect to FIG. 4, each node further includes a north port, a south port, an cast port, and a west port; and each port further includes an input and an output port. As such each node includes a north-input port and a north-output port; a south-input port and a south-output port; an cast-input port and an cast-output port; and a west-input port and a west-output port.

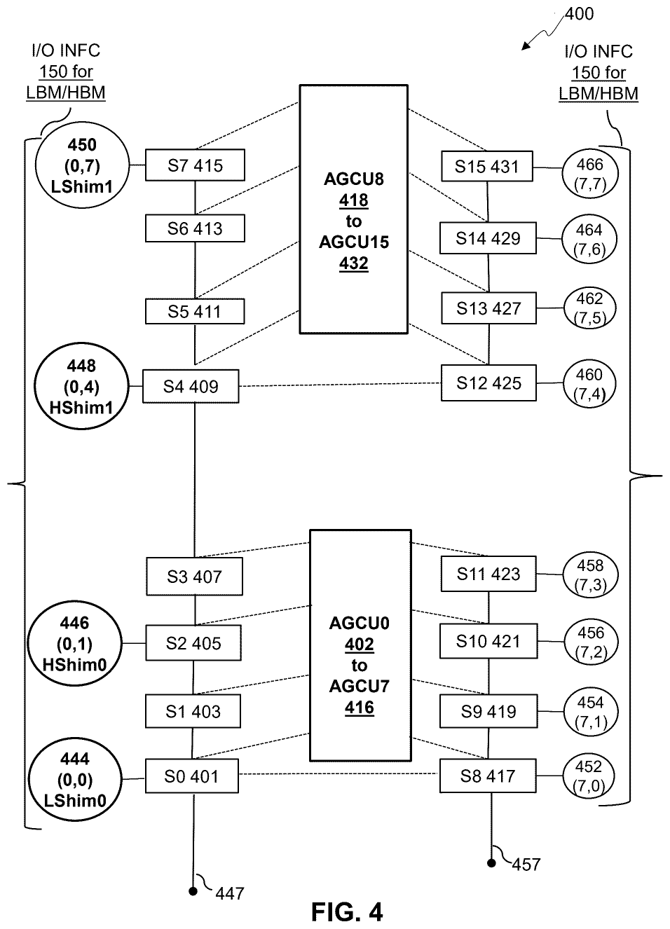

FIG. 5 illustrates an example diagram of a portion of the TLN 400 including a plurality of TLN switches 511, 512, 521, 522, 531, and 532 coupled to various memory interfaces (LBM or HBM Shims, also known as agents) 541, 542, 543, 551, 552, and 553. The TLN switches 511, 512, 521, 522, 531, and 532 can be examples of the switches S0 401 to S15 431. The LBM/HBM Shims 541, 542, 543, 551, 552, and 553 can be examples of the LBM/HBM Shims 452, 454, 456, 458, 460, 462, 464, and 466 shown in FIG. 4. Specifically, the TLN switches 511, 521, and 531 are coupled to agents 541, 542, and 543 respectively and the switches 512, 522, and 532 are coupled to the agents 551, 552, and 553 respectively. All of the switches are also interconnected to their adjacent switches as shown by the bidirectional arrows. As those skilled in the art may appreciate LBM and HBM can have various speeds, resulting in various bandwidths are indicated by their interfaces in FIG. 5.

For example, the agents 541, 542, 543, 551, 552, 553 may require bandwidths bw1, bw2, bw3, bw4, bw5, and bw6 respectively.

Also shown in FIG. 5 are data flows flow1 561, flow2 562, and flow3 563.

These flows originate from the memory interfaces 541, 543, and 553 respectively trying to access 551 via the switch 512.

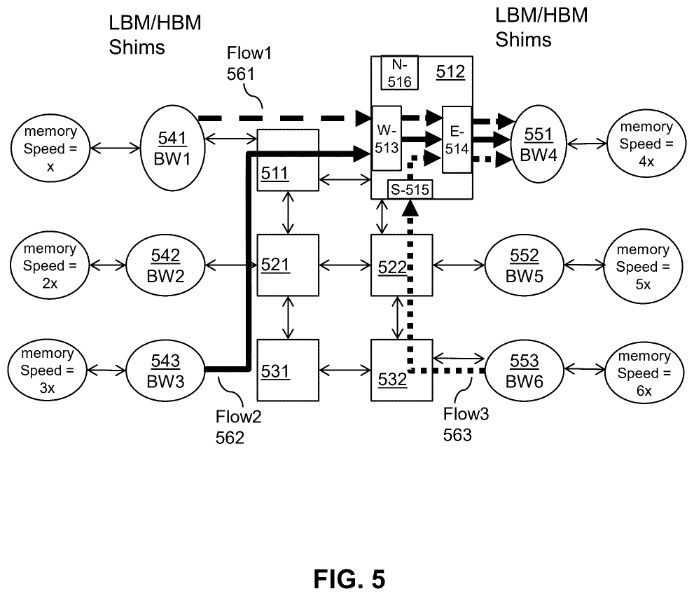

As will be explained in FIG. 6, each TLN switch includes multiple ports in each direction for facilitating communication among adjacent switches.

FIG. 6 illustrates an example TLN switch including multiple ports and a flow control logic. In one example, there is a north port 620 including a north input port n-in 621 and a north output port n-out 622, a south port 630 including a south input port s-in 631 and a south output port s-out 632, an cast port 640 including an cast input port e-in 641 and an cast output port e-out 642, and a west port 610 including a west input port w-in 611 and a west output port w-out 612. Although the TLN switch in FIG. 6, is illustrated to include a single north port, a single south port, a single cast port, and a single west port. In one example, a single TLN switch can have four north ports, four south ports, one cast port, and one west port. In other examples, there can be any number of ports in either direction. In general, the south input port s-in may be referred to as “s-in port or port s-in,” the north input port n-in may be referred to as “n-in port or port n-in,” the cast input port e-in may be referred to as “e-in port or port e-in,” and the west input w-in may be referred to as “w-in port or port w-in.” In some examples, a TLN switch can include multiple north, south, cast, and west ports. In some other examples, the TLN switch may include an additional local port to communicate with the AGCUs. An example of such an implementation is described in a related U.S. Nonprovisional patent application Ser. No. 18/107,690, filed Feb. 9, 2023, entitled “Two-level arbitration in a reconfigurable processor.” It may be understood that for any switch the incoming data or flow to any input port may directed to any of the three other output ports depending on its destination output port. For example, in the case of switch 600, the incoming flows flow1, flow2, and flow3 are all directed to the cast port 640.

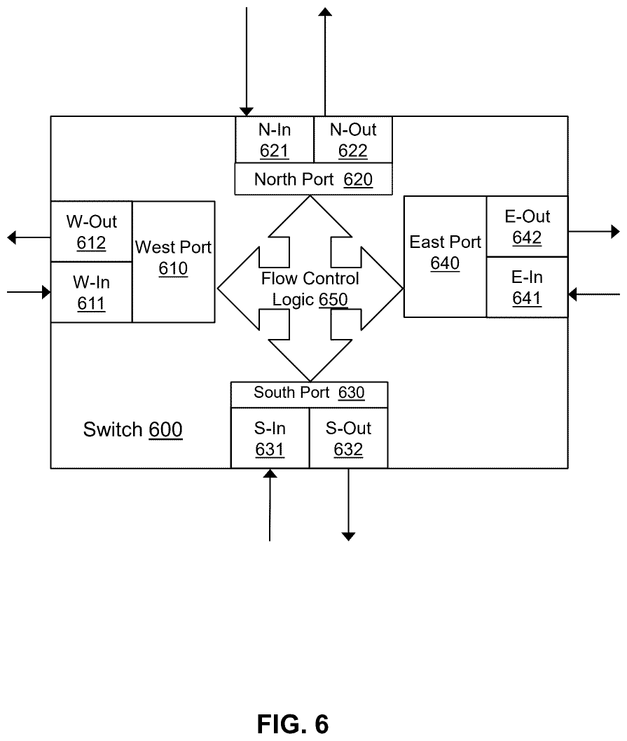

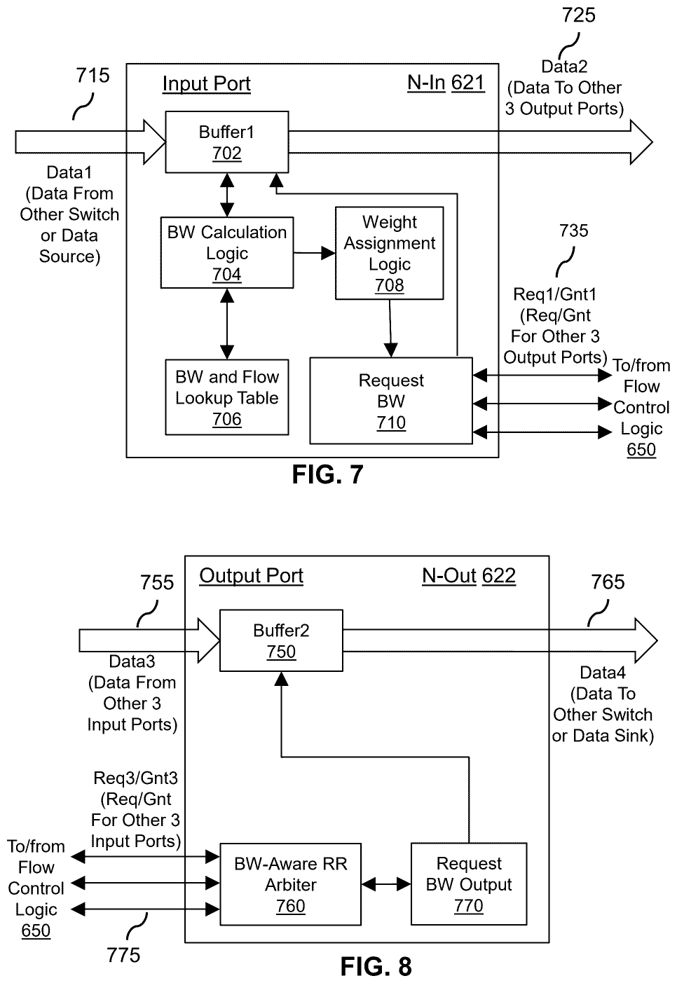

Referring to FIG. 5, it can be understood that each of the TLN switches 511, 521,531, 512, 522, and 532 include the east, west, north, and south ports and the dataflows enter and exit any switch using the above-mentioned ports using their corresponding directions. Specifically, the switch 512 includes a west port w-513, and an cast port e-514, a north port n-516, and a south port s-515. Furthermore, it may be understood that flow1 561 having the bandwidth bw1 and flow2 562 having the bandwidth bw3 enter the switch 512 through its west port w-513 and the flow3 having the bandwidth bw6 enters the switch 512 via its south port s-515. The west and south ports of the switch 512 in this example can be considered as active input ports. Furthermore, both the active ports (west and south ports) request access of the cast port e-514. The cast port may be referred to as a “destination port”. In one example, each TLN switch implements a bandwidth-aware weighted round robin arbiter (hereinafter “arbiter”) in its output port. The arbiter selects the active input ports to be coupled to destination for a time that is proportional to their bandwidths. More details about the input and output ports included in a TLN switch will be described with regard to FIG. 7 and FIG. 8.

FIG. 7 illustrates an example block diagram of an input port of any TLN switch shown in FIG. 5. The input port shown in FIG. 7 is the north input port n-in 621 shown in FIG. 6. The n-in 621 port includes a buffer buffer1 702, a bandwidth (BW) calculation logic 704, a BW and flow lookup table 706, a weight assignment logic 708, and a request BW input block 710. In one example, the buffer1 702 receives data1 715 which is data from another switch or data source and further sources it to any or all of the other three outputs as indicated by data2 725.

The BW calculation logic 704 then calculates the bandwidth required for the data based on its source. For example, referring to FIG. 5, it may be understood that the BW calculation logic 704 in the switch 512 calculates the BW to be equal to “x” for flow1 561. The BW and flow lookup table 706 can be used for calculation of a bandwidth. Furthermore, the weight calculation logic assigns a weight to each port based on the flows that it receives. If there are two flows entering the port, then the weight calculation logic based on the calculated BW, then a sum of all the weights is calculated for each port. For example, in FIG. 5, it may be assumed that flow1's weight is w1, flow2's weight is w2, and flow3's weight is w3 based on their bandwidths. Since both flow1 and flow2 are entering the same port, their weights may be added, and the port is assigned a total weight equal to (w1+w2.) Since flow3 enters the south port, the weight for the south port is w3. As explained earlier, for any switch the incoming data to any input port is directed to any of the three other output ports. In one example, the flow control logic 650 directs an incoming flows to its destination port.

The request BW input block 710 is coupled to work with the flow control logic 650 to send a request to access any of the other inputs and to receive a grant in return of the request via the request/grant signals shown as 735. If the request is granted by the flow control logic 650, then the data1 715 can be sent to the desired destination output port via the buffer1 702.

For example, in case of the switch 600, the active input port is the west port and any data coming in through the west port can be granted access to the other three ports including e-out port 642, n-out port 622, and s-out port 632. In other words, grants signals can be provided to e-out 642, n-out 622, and s-out 632 (shown in FIG. 6) to which the incoming data is directed. In other words, initially the request bw input block 710 can send a request to the flow control logic 650 to access any of the other desired output ports (south, west, or cast). After the flow control logic 650 grants that request, the request bw input block 710 can receive the grant and further allow the data1 from the buffer1 702 to be provided to the desired output port. As will be explained with respect to FIG. 8, an output port includes a bw-aware arbiter which arbitrates the access of the desired output port for a time proportional to the weight of their ports. In one example, each input port sends a request to the bw-aware arbiter indicating its weight “X”. The arbiter arbitrates and then locks the arbitration for X cycles (serving the winning input port its share of BW (X)). After X cycles the arbiter is able to handle the next arbitration round.

FIG. 8 illustrates an example block diagram of an output port of any TLN switch shown in FIG. 5. The output port shown in FIG. 8 is n-out 622 previously shown in FIG. 6. The n-out 622 includes a buffer buffer2 750, a bw-aware weighted RR arbiter 760, and a request BW output block 770. The buffer2 750 is coupled to receive data data3 755 from the three other input ports, (which in this example are cast, west, south ports) and provide that to another switch or data sink as indicated by data4 765.

The arbiter 760 is coupled to receive request/grants for the three input ports (shown an shown as req3/gran3 775) via the flow control logic 650 which may be requesting access to the output port n-out 622. The request bw output block 770 is coupled to work with the arbiter 760 to provide data3 to any other switch or data sink.

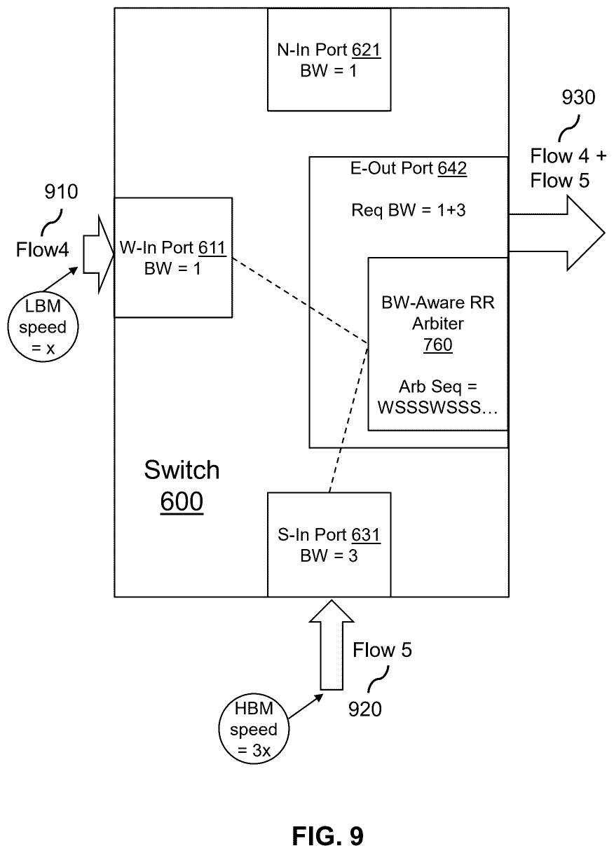

FIG. 9 is an example implementation of a weighted RR arbiter arbitrating multiple flows in a TLN switch. FIG. 9 illustrates the switch 600 coupled to receive two data flows flow4 910 through the w-in port 611 and flow5 920 through the s-in port 631. Both the flows request access to the output port e-out 642. The switch includes the bw-aware RR arbiter 760. Other logic blocks shown in FIGS. 7 and 8 in the input and output ports are coupled to work in a way described previously.

The flow4 910 has a bandwidth of “1” and the flow5 920 has a bandwidth of “3” meaning that flow4 910 is coupled to an LBM and flow5 920 is coupled to an HBM. It may be assumed that the bandwidth calculation logic and the weight assignment logic (shown in FIG. 7) assign a weight 1 to the w-in port 611 and a weight of 3 to the s-in port 631. The total weight for both the ports is 4. In one example, the arbiter 760 arbitrates the two active input ports, the west input port w-in 611 and the south input port s-in 631 to the output port e-out 642 for a time proportional to their weights. In one example, there are four cycles of arbitration equal to the total weight of both the ports. Out of the four cycles, the w-in port 611 is given access for one cycle and the s-in port 631 is given access for three cycles. In one example, the arbitration sequence may be WSSSWSSS, where “W” stands for the w-in port 611 and the “S” stands for the s-in port 631.

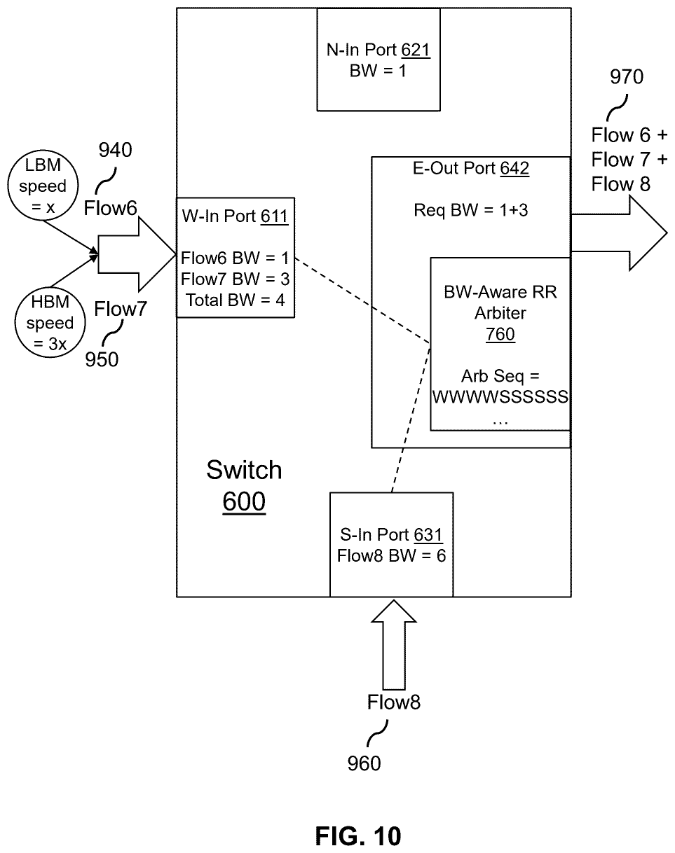

FIG. 10 is an example implementation of a weighted RR arbiter arbitrating multiple flows in a TLN switch. FIG. 10 illustrates the switch 600 coupled to receive three data flows: flow6 940 and flow7 950 through the w-in port 611 and flow8 960 through the s-in port 631. In this example, all the flows are requesting access to the port e-out 642. The switch includes the bw-aware RR arbiter 760. Other logic blocks shown in FIG. 7 and FIG. 8 in the input and output ports are coupled to work in a way described previously.

In this example, the flow6 940 has a bandwidth of 1 and the flow7 950 has a bandwidth of 3 making the total bandwidth for the w-in port 611 equal to 4. The flow8 960 has a bandwidth of 6 for the s-in 631. In this example, the bandwidth calculation logic and the weight assignment logic (shown in FIG. 7) assign a weight of 4 (equal to the total bandwidth of flow6 940 and flow7 950) to the w-in port 611. Similarly, a weight of 6 is assigned to the s-in 631. The total weight of the w-in 611 and s-in 631 ports equals 10, so the number of arbitration cycles is equal to 10. In one example, the arbiter 760 arbitrates the two active input ports w-in 611 and s-in 631 to the output port e-out 642 for a time proportional to their weights. Out of the 10 cycles, the w-in port 611 gets access to the e-out 642 port for four cycles and the s-in 631 port gets access for six cycles generating the flows flow6 940+flow7 950+flow8 960, collectively shown as 970, at the e-out port 642. In one example, the arbitration sequence may be WWWWSSSSSS, where “W” stands for the w-in port and the “S” stands for the s-in port. In other examples the weight assignment logic 708 can assign any weight that is proportional to its bandwidth.

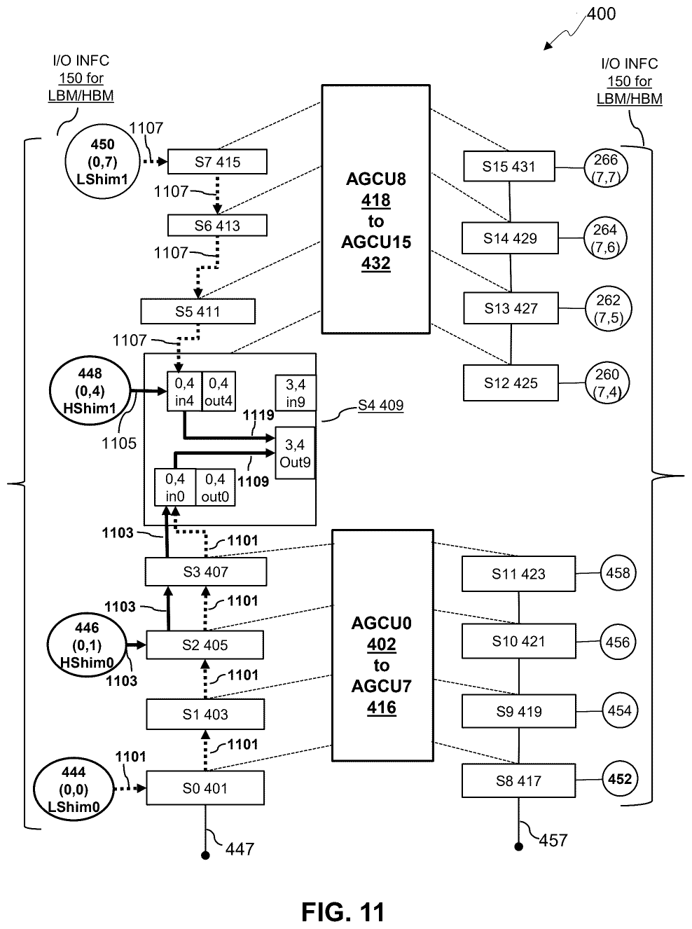

Further shown in FIG. 11 are multiple flows sending traffic to the switch S4 409, including a first flow 1101, a second flow 1103, a third flow 1105, and a fourth flow 1107. The first flow 1101 is from LShim0 444 to S0 401 to S1 403 to S2 405 to S3 407 to S4 409. The second flow 1103 is from Hshim0 446 to S2 405 to S3 407 to S4 409. The third flow 1105 is from Hshim1 448 to S4 409, and the fourth flow 1107 is from LShim1 450 to S7 415 to S6 413 to S5 411 to S4 409. The flows 1101 and 1103 are coupled to enter the node (0,4) of the switch S4 409 via the south input port in0 and the flows 1105 and 1107 are coupled to enter the node (0,4) of the switch S4 409 via the north input port in4. Looking at the switch S4 409, there are two final active flows including the flow 1109 resulting from the flows 1101 and 1103 and the flow 1119 resulting from the flows 1105 and 1107.

Additionally, there are two active inputs in0 and in4 requesting access to the output port out9 of the node (3,4). (Intermediate nodes are not shown.)

In one example, the switch S4 409 implements a bandwidth-aware weighted round robin (RR) arbiter to arbitrate the two active input ports in0 and in4 to the output port out9 of the node (3,4). In one example, a weight is assigned to each active flow entering an input port and all the weights are added for each active input port. Each flow is then given access to the output port based on each input port's assigned weight.

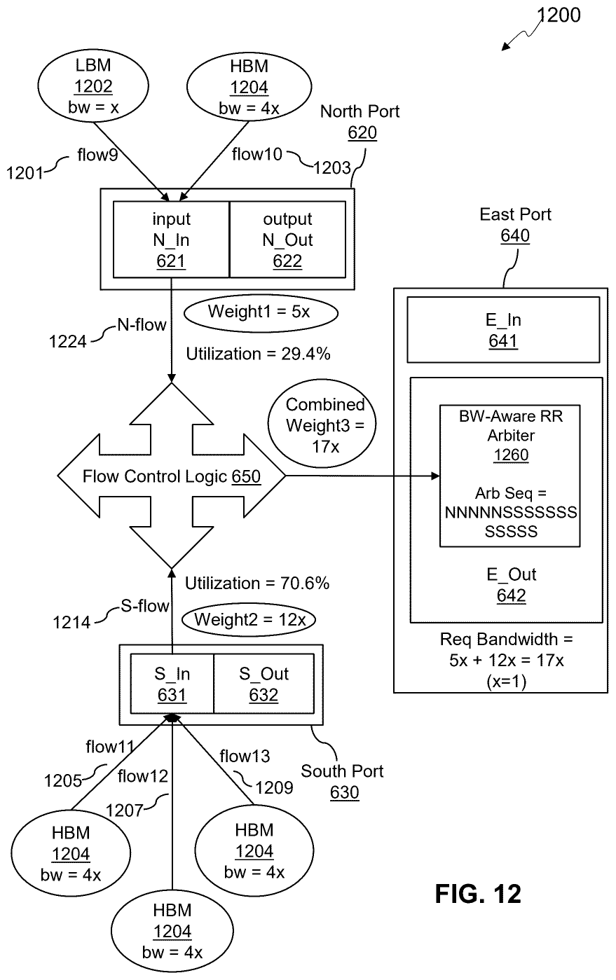

FIG. 12 illustrates an example diagram 1200 of arbitration of multiple data flows to a single output port, according to an embodiment of the present disclosure. FIG. 12 illustrates a portion of the switch 600 along with the flow control logic 650. Specifically shown in FIG. 12 are a north port 620, a south port 630, and the cast port 640. In this example, there are two active input ports (north port 620 and south port 630) and one active port (east port 640). The two active input ports, namely, the north port 620 and the south port 630 are coupled to receive data flows and provide those to the active output port (cast port) 640.

More particularly, the north port 620 is coupled to received two data flows flow9 1201 and flow10 1203 via its input n-in 631. The flows9 originates from LBM 1202 requiring a bandwidth equal to “x” and flow10 1203 originates from HBM 1204 requiring a bandwidth equal to four times of “x” (4x.) For example, the LBM 1202 may be a DDR memory with a required bandwidth of 16 Gbps and the HBM 1204 may be any other high bandwidth memory with a required bandwidth of 64 Gbps. The combined active flow of flow9 and flow10 can be referred to as the n-flow 1224 and the combined active flow of flow11 1205, flow12 1207, and flow13 1209 can be referred to as the s-flow 1214.

Similarly, the south port 630 is coupled to receive three data flows flow11 1205, flow12 1207, and flow13 1209 via its input s-in 631. All the flows flow11 1205, flow12 1207, and flow13 1209 originate from HBM 1204 requiring a bandwidth equal to “4x”. All of the ports are coupled to the flow control logic 650. Although not shown in FIG. 12, the switch 600 also includes other logic blocks shown in FIG. 7 and FIG. 8, such as bw and flow look up table, bw calculation logic, weight assignment logic, request bandwidth block in the input and output ports. All of these blocks are operatively coupled to function in a way as explained with regard to FIG. 7 and FIG. 8.

Further shown in the e-out port 642, is a bw-aware RR arbiter 1260, which is one example of the arbiter 760 shown in FIG. 8. The flow control logic 650 manages the incoming and outgoing flows and also works with requests and grants for various input and output ports.

In one example, initially, the bw and flow lookup table, the bw calculation logic, and the weight assignment logic in the active input ports (n-in 621 and s-in 631) assign weights to the active input flows proportional to a sum of their required bandwidths. As such, the combined weight for the n-in port 621 is five times of “x” (5x) shown as weight1. Similarly, the combined weight for the s-in port 631 port is twelve times of “x” (12x) shown as weight2. Additionally, in this example, the combined bandwidth for the active ports n-in and the s-in port is 17x. Assuming x is to be equal to 1, the combined bandwidth for active ports is equal to 17.

Embodiment #1: In one example, the arbiter 1260 performs an arbitration cycle for a time which is proportional to the combined bandwidth for all the active ports. Furthermore, in a single arbitration cycle, the arbiter 1260 selects the active input ports n-in 621 and s-in 631 to arbitrate for the output port e-out 642 for a time proportional to their weights. In this example, the arbiter performs a single arbitration cycle for a time which is a multiple of 17. Furthermore, in a single arbitration cycle, arbiter selects the n-in port 621 for a time proportional to 5 cycles and the s-in port 631 for a time proportional to 12 cycles. In other words, the n-in port 621 is selected for 29.4 percent of the total arbitration time and the s-in 631 port is selected for 70.6 percent of the total arbitration time. As such in one example, the n-in 621 port gets 29.4 percent utilization and the s-in 631 port gets 70.6 percent utilization.

Embodiment #2: In one example, the arbiter 1260 performs as many arbitration cycles as equal to the combined bandwidth for all the active ports. As such, the arbiter performs 17 arbitration cycles and out of those 5 cycles are for the n-in port 621 and 12 cycles are for the s-in port 631. Furthermore, it should be noted that in one example, the arbiter can continue to do arbitration as long as there are packets waiting at least one input port. In other words, the arbiter locks its decision for X cycles if the winning input ports weight was X. Once the X cycles has passed (serving the winning input port's BW) the arbiter is ready to do a new arbitration.

In some examples, the arbiter 1260 can implement a priority-based scheme or any other scheme resulting in providing to an input port, a time utilization proportional to its bandwidth and weight. In some examples, the higher the bandwidth or weight, the greater the utilization; and the lower the bandwidth or weight the lesser the utilization. Such a priority-based scheme can be used for a service level agreement, configuration, or a class of service configuration.

As explained earlier, arbitration is only needed when there is contention i.e., when multiple input ports are waiting to send packets to a particular output port in the same cycle. In the example of FIG. 12, since two ports n-in 621 and s-in 631 are trying to send data (flows) to the e-out 642, arbitration is required, however, if only one of the two ports were trying to send data (flow) to the e-out 642, then no arbitration would have been required and the flow would have been sent to the e-out 642 immediately. Additionally, explained earlier, data transfer between any two adjacent switches is facilitated by hop credits meaning that data is transferred from a source switch to an adjacent destination switch if there are any credits available in the destination switch. As such, in the example of FIG. 12, the arbiter 1260 becomes active if there are hop credits available for the output port e-out 642. Additionally, as explained earlier, a requirement for an arbiter to become active is that packets should be ready to go in the input port buffers. In this example, the arbiter 1260 becomes active once the packets are ready in n-in 621 and s-in 631 ports.

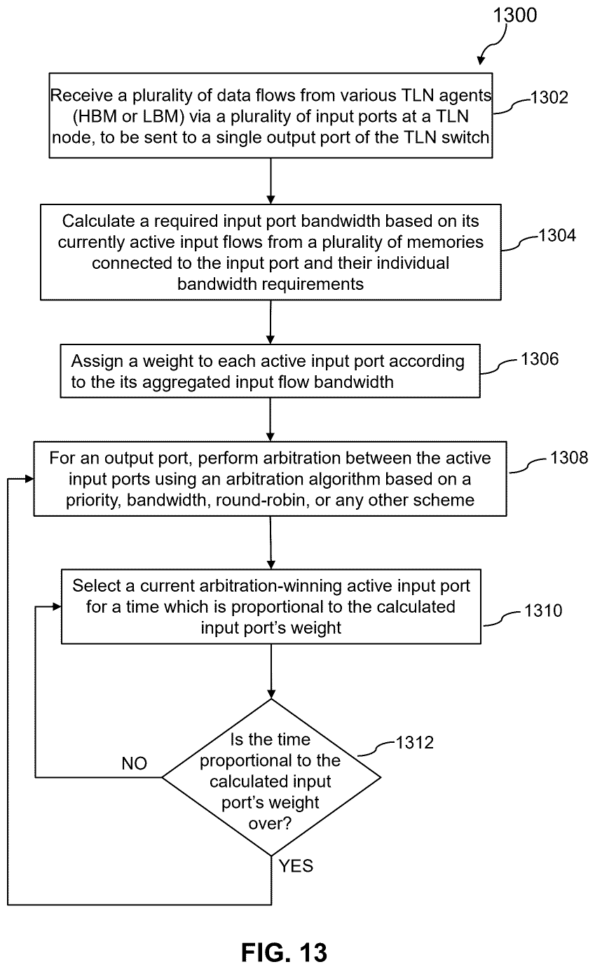

FIG. 13 illustrates an example flow diagram for method 1300 to arbitrate a plurality of flows in a TLN network in a reconfigurable processor. The reconfigurable processor can be processor shown in FIG. 1.

As shown at step 1302, a TLN node receives a plurality of data flows from various TLN agents (HBM or LBM) via a plurality of input ports at a TLN node, to be sent to a single output port of the TLN switch. For example, in FIG. 9, flow4 910 and flow5 920, collectively indicated as flow4+flow5 930, are received by the switch 600 to be sent to the port e-out 642. The method then proceeds to step 1304.

At step 1304, a required input port bandwidth based on its currently active input flows (from one or more memories) can be calculated. For example, as shown in FIG. 4, FIG. 7, and FIG. 9, the flow control logic 650 can use the BW calculation logic and the BW and flow lookup table 706, to calculate the bandwidth for the w-in port 611 to be equal to one since the bandwidth of flow4 910 is one. The method then proceeds to step 1306.

At step 1306, a weight is assigned to each active input port according to its aggregated input flow bandwidth. For example, as shown in FIG. 4, FIG. 7, the weight assignment logic 708 calculates the weight for the w-in port 611 in FIG. 9 to be equal to 1 since the bandwidth of flow4 910 is one. The method then proceeds to step 1308.

At step 1308, an arbiter may perform arbitration for an output port performed between the active input ports using an arbitration algorithm based on a priority, bandwidth, round-robin, or any other scheme. For example, in FIG. 9, the arbiter selects both the ports w-in 611 and s-in 631 to arbitrate for the output port e-out 642. The method then proceeds to step 1310.

At step 1310, a current arbitration-winning active input port may be selected for a time which is proportional to the calculated input port's weight. For example, in FIG. 9, the s-in 631's weight is 3 and the w-in 611's weight is 1, therefore, the arbiter 760 selects the s-in 631 port for triple the amount of time than the w-in port 611 as shown by the arbitration sequence WSSSWSSS. The method then proceeds to step 1312.

At step 1312, it may be checked if the time proportional to the selected input port's weight is over. If not, then the arbiter continues to keep the selected input coupled to the output. For example, in FIG. 9, the arbitration sequence “WSSSWSSS” based on the weights, there is 1 “W” (for w-in 611) and 3 “S”s for (s-in 631). Initially, W cycle is completed. After that when the “S” cycle starts, until the 3 “S” are completed, the arbiter keeps selecting the s-in 631 input to provide to the output port e-out 642. Once the 3 “S” cycles are complete, then the “W” is selected for the next cycle again.

Example 1. A computing system comprising: a host computer; a communication link coupled to the host computer; first external memory of a first type; second external memory of a second type; and a reconfigurable processor coupled to the communication link and comprising:
a network that includes a plurality of switches; an array of configurable units, connected to the network, and configured to execute an application; an array-level network connecting configurable units within the array of configurable units; a tile agent coupled between the network and the array-level network; a host agent coupled between the host computer and the network; a first memory agent coupled between the first external memory and the network; and a second memory agent coupled between the second external memory and the network; a switch of the plurality of switches comprising: a plurality of output ports including a first output port and a second output port;
a plurality of input ports including a first input port and a second input port;
a first bandwidth calculation circuit configured to calculate a first requested bandwidth for first packets received through the first input port to send through the first output port, and to calculate a third requested bandwidth for third packets received through the first input port to send through the second output port; a second bandwidth calculation circuit to calculate a second requested bandwidth for second packets received through the second input port to send through the first output port, and to calculate a fourth requested bandwidth for fourth packets received through the second input port to send through the second output port; a first bandwidth-weighted round-robin arbiter configured to, during a first round-robin period, select the first input port for a first number of data transfers based on the first requested bandwidth, and to select the second input port for a second number of data transfers based on the second requested bandwidth; a second bandwidth-weighted round-robin arbiter configured to, during a second round-robin period, select the first input port for a third number of data transfers based on the third requested bandwidth, and to select the second input port for a fourth number of data transfers based on the fourth requested bandwidth; and a data transfer circuit to accept data from the plurality of input ports and send the data to the plurality of output ports.

Example 2. An integrated circuit comprising a network that includes a plurality of switches, a switch of the plurality of switches comprising: a plurality of output ports including a first output port; a plurality of input ports including a first input port that has a first bandwidth calculation circuit to calculate a first requested bandwidth for first packets received through the first input port to send through the first output port, and a second input port that has a second bandwidth calculation circuit to calculate a second requested bandwidth for second packets received through the second input port to send through the first output port; a first bandwidth-weighted round-robin arbiter configured to, during a round-robin period, select the first input port for a first number of data transfers based on the first requested bandwidth, and to select the second input port for a second number of data transfers based on the second requested bandwidth; and a first data transfer circuit to accept data from the plurality of input ports and send the data to the first output port.

Example 3. The integrated circuit of example 2, the first bandwidth calculation circuit further configured to: examine first information included with the first packets to determine a first flow that includes a first subset of the first packets that have a first common origination agent; determine a first flow bandwidth for the first flow; and use the first flow bandwidth to calculate the first requested bandwidth.

Example 4. The integrated circuit of example 3, the first bandwidth calculation circuit further configured to: examine the first information to determine that there are no other active flows, other than the first flow, in the first packets; and use the first flow bandwidth as the first requested bandwidth.

Example 5. The integrated circuit of example 3, the first bandwidth calculation circuit configured to determine the first flow bandwidth by using a table to lookup the first flow bandwidth for the first common origination agent.

Example 6. The integrated circuit of example 3, the first bandwidth calculation circuit further configured to: examine the first information to determine a second flow that includes a second subset of the first packets that have a second common origination agent; determine a second flow bandwidth for the second flow; and use the first flow bandwidth and the second flow bandwidth to calculate the first requested bandwidth.

Example 7. The integrated circuit of example 6, the first bandwidth calculation circuit further configured to: examine the first information to determine that there are no other active flows, other than the first flow and the second flow, in the first packets; and use a sum of the first flow bandwidth and the second flow bandwidth as the first requested bandwidth.

Example 8. The integrated circuit of example 6, the first bandwidth calculation circuit further configured to determine the first flow bandwidth and the second flow bandwidth by using a table to lookup the first flow bandwidth for the first common origination agent and to lookup the second flow bandwidth for the second common origination agent, wherein both the first flow bandwidth and the second flow bandwidth are integer values less than or equal to 255 and represent a requested number of transfers per round-robin period for the first output port.

Example 9. The integrated circuit of example 8, further comprising: an array of configurable units, connected to the network, and configured to execute an application;
an array-level network connecting configurable units within the array of configurable units;
a tile agent coupled between the network and the array-level network;
a host agent coupled between an external data processing resource and the network;
a first memory agent coupled between first external memory and the network; and
a second memory agent coupled between second external memory and the network.

Example 10. The integrated circuit of example 9, wherein the first memory agent is the first common origination agent, the first external memory comprises double-data-rate (DDR) memory able to provide data to the network at a first data rate, the second memory agent is the second common origination agent, and the second external memory comprises high-bandwidth memory (HBM) memory able to provide data to the network at a second data rate, wherein a first ratio of the first flow bandwidth to the second flow bandwidth is between 50% and 150% of a second ratio of the first data rate to the second data rate.

Example 11. The integrated circuit of example 8, wherein the round-robin period includes a first period during which the first number of data transfers from the first input port to the first output port occur, a second period during which the second number of data transfers from the second input port to the first output port occur, and no other period during which data is transferred from either the first input port or the second input port to the first output port before starting a new round-robin period, wherein the first number of data transfers is equal to the first requested bandwidth, and the second number of data transfers is equal to the second requested bandwidth.

Example 12. The integrated circuit of example 2, the switch further comprising: a second output port in the plurality of output ports; a second bandwidth-weighted round-robin arbiter; and a second data transfer circuit to accept data from the plurality of input ports and send the data to the second output port; wherein the first bandwidth calculation circuit is further configured to calculate a third requested bandwidth for third packets received through the first input port to send through the second output port; the second bandwidth calculation circuit is further configured to calculate a fourth requested bandwidth for fourth packets received through the second input port to send through the second output port; and the second bandwidth-weighted round-robin arbiter is configured to, during a second round-robin period, select the first input port for a third number of data transfers based on the third requested bandwidth, and to select the second input port for a fourth number of data transfers based on the fourth requested bandwidth.

Example 13. A method for use in a switch of in a mesh network, the method comprising:
receiving, from a first neighbor switch output or a first network agent at a first input of the switch, first packets that are to be forwarded to a first output of the switch; calculating a first requested bandwidth by examining first information included with the first packets; receiving, from a second neighbor switch output or a second network agent at a second input of the switch, second packets that are to be forwarded to the first output of the switch; calculating a second requested bandwidth by examining second information included with the second packets;
transferring a first amount of data from the first input to the first output during a first round-robin period of a first arbiter, wherein the first amount of data is based on the first requested bandwidth; and transferring a second amount of data from the second input to the first output during the first round-robin period, wherein the second amount of data is based on the second requested bandwidth.

Example 14. The method of example 13, wherein the first round-robin period includes a first period during which a first number of data transfers from the first input to the first output occur, a second period during which a second number of data transfers from the second input to the first output occur, and no other period during which data is transferred from either the first input or the second input to the first output before starting a new round-robin period, wherein the first number of data transfers is equal to the first requested bandwidth, and the second number of data transfers is equal to the second requested bandwidth.

Example 15. The method of example 13, further comprising: determining, based on the first information, that the first packets include a first flow that includes a first subset of the first packets that have a first common origination agent; determine a first flow bandwidth for the first flow; and use the first flow bandwidth to calculate the first requested bandwidth.

Example 16. The method of example 15, further comprising: determining, based on the first information, that there are no other active flows, other than the first flow, in the first packets; and using the first flow bandwidth as the first requested bandwidth.

Example 17. The method of example 15, further comprising using a table to look up the first flow bandwidth based on the first common origination agent.

Example 18. The method of example 15, further comprising: determining, based on the first information, that the first packets include a second flow that includes a second subset of the first packets that have a second common origination agent; determine a second flow bandwidth for the second flow; and use the first flow bandwidth and the second flow bandwidth to calculate the first requested bandwidth.

Example 19. The method of example 18, further comprising: determining, based on the first information, that there are no other active flows, other than the first flow and the second flow, in the first packets; and using a sum of the first flow bandwidth and the second flow bandwidth as the first requested bandwidth.

Example 20. The method of example 18, further comprising using a table to lookup the first flow bandwidth for the first common origination agent and to lookup the second flow bandwidth for the second common origination agent, wherein both the first flow bandwidth and the second flow bandwidth are integer values less than or equal to 255 and represent a requested number of transfers per round-robin period for the first output.

Example 21. The method of example 13, further comprising: receiving, from the first neighbor switch output or a third network agent at the first input of the switch, third packets that are to be forwarded to a second output of the switch; calculating a third requested bandwidth by examining third information included with the third packets; receiving, from the second neighbor switch output or a fourth network agent at the second input of the switch, fourth packets that are to be forwarded to the second output of the switch; calculating a fourth requested bandwidth by examining fourth information included with the fourth packets; transferring a third amount of data from the first input to the second output during a second round-robin period of a second arbiter, wherein the third amount of data is based on the third requested bandwidth; and transferring a fourth amount of data from the second input to the second output during the second round-robin period, wherein the fourth amount of data is based on the fourth requested bandwidth.

Example 21: A non-transitory machine-readable medium comprising computer instructions that, in response to being executed by a processor, cause the processor to use in a switch of in a mesh network, by: receiving, from a first neighbor switch output or a first network agent at a first input of the switch, first packets that are to be forwarded to a first output of the switch; calculating a first requested bandwidth by examining first information included with the first packets; receiving, from a second neighbor switch output or a second network agent at a second input of the switch, second packets that are to be forwarded to the first output of the switch; calculating a second requested bandwidth by examining second information included with the second packets; transferring a first amount of data from the first input to the first output during a first round-robin period of a first arbiter, wherein the first amount of data is based on the first requested bandwidth; and transferring a second amount of data from the second input to the first output during the first round-robin period, wherein the second amount of data is based on the second requested bandwidth.

Example 22. The non-transitory machine-readable medium of example 1, wherein the first round-robin period includes a first period during which a first number of data transfers from the first input to the first output occur, a second period during which a second number of data transfers from the second input to the first output occur, and no other period during which data is transferred from either the first input or the second input to the first output before starting a new round-robin period, wherein the first number of data transfers is equal to the first requested bandwidth, and the second number of data transfers is equal to the second requested bandwidth.

Example 23. The non-transitory machine-readable medium of example 1, further comprising: determining, based on the first information, that the first packets include a first flow that includes a first subset of the first packets that have a first common origination agent; determining a first flow bandwidth for the first flow; and using the first flow bandwidth to calculate the first requested bandwidth.

Example 24. The non-transitory machine-readable medium of example 3, further comprising: determining, based on the first information, that there are no other active flows, other than the first flow, in the first packets; and using the first flow bandwidth as the first requested bandwidth.

Example 25. The non-transitory machine-readable medium of example 3, further comprising using a table to look up the first flow bandwidth based on the first common origination agent.

Example 26. The non-transitory machine-readable medium of example 3, further comprising: determining, based on the first information, that the first packets include a second flow that includes a second subset of the first packets that have a second common origination agent; determining a second flow bandwidth for the second flow; and using the first flow bandwidth and the second flow bandwidth to calculate the first requested bandwidth.

Example 27. The non-transitory machine-readable medium of example 6, further comprising: determining, based on the first information, that there are no other active flows, other than the first flow and the second flow, in the first packets; and using a sum of the first flow bandwidth and the second flow bandwidth as the first requested bandwidth.

Example 28. The non-transitory machine-readable medium of example 6, further comprising using a table to lookup the first flow bandwidth for the first common origination agent and to lookup the second flow bandwidth for the second common origination agent, wherein both the first flow bandwidth and the second flow bandwidth are integer values less than or equal to 255 and represent a requested number of transfers per round-robin period for the first output.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), recurrent neural networks (RNNs), graph neural networks (GNNs), convolutional neural networks (CNNs), graph convolutional networks (GCNs), long short-term memory (LSTM) networks, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, which may be used as deep learning accelerators, are processors such as central processing unit (CPUs), CGR processor ICs, graphics processing units (GPUs), FPGAs, ASICs, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

In one embodiment, each of the AGCUs may be allocated a specific bandwidth to access TLN. This is similar to VAGs participating and winning arbitration to get access to the TLN. For example, the CGR processor 110 may include one or more AGCU arbiters to arbitrate among the AGCUs 202 to 232 to gain access to the TLN agents 244 to 266. The arbiter may be implemented in hardware or software or both.

In one example, a software implemented arbiter may keep a table of AGCUs and their need to access the external memory devices or host. Those AGCUs which have a higher bandwidth demand to access the external memory devices or host, may be assigned a higher priority than those which have a lower need. The higher priority AGCUs may be selected to access TLN. In other words, the higher priority AGCUs may get more bandwidth on the TLN than the lower priority ones.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the implementations described herein.

Although the description has been described with respect to particular implementations thereof, these particular implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations in the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented in a CGRA system, a System-on-Chip (SoC), application-specific integrated circuit (ASIC), programmable processor, in a programmable logic device such as a field-programmable gate array (FPGA) or a graphics processing unit (GPU), obviating a need for at least part of the dedicated hardware. Implementations may be as a single chip, or as a multi-chip module (MCM) packaging multiple semiconductor dies in a single package. All such variations and modifications are to be considered within the ambit of the present disclosed technology, the nature of which is to be determined from the foregoing description.

One or more implementations of the technology or elements thereof can be implemented in the form of a computer product, including a non-transitory computer-readable storage medium with computer usable program code for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or an RDU that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit of the technology disclosed.

1. A computing system comprising:
a host computer;
a communication link coupled to the host computer;
first external memory of a first type;
second external memory of a second type; and
a reconfigurable processor coupled to the communication link and comprising:
a network that includes a plurality of switches;
an array of configurable units, connected to the network, and configured to execute an application;
an array-level network connecting configurable units within the array of configurable units;
a tile agent coupled between the network and the array-level network;
a host agent coupled between the host computer and the network;
a first memory agent coupled between the first external memory and the network;
a second memory agent coupled between the second external memory and the network; and
a switch of the plurality of switches comprising:
a plurality of output ports including a first output port and a second output port;
a plurality of input ports including a first input port and a second input port;
a first bandwidth calculation circuit configured to calculate a first requested bandwidth for first packets received through the first input port to send through the first output port, and to calculate a third requested bandwidth for third packets received through the first input port to send through the second output port;
a second bandwidth calculation circuit to calculate a second requested bandwidth for second packets received through the second input port to send through the first output port, and to calculate a fourth requested bandwidth for fourth packets received through the second input port to send through the second output port;
a first bandwidth-weighted round-robin arbiter configured to, during a first round-robin period, select the first input port for a first number of data transfers based on the first requested bandwidth, and to select the second input port for a second number of data transfers based on the second requested bandwidth;
a second bandwidth-weighted round-robin arbiter configured to, during a second round-robin period, select the first input port for a third number of data transfers based on the third requested bandwidth, and to select the second input port for a fourth number of data transfers based on the fourth requested bandwidth; and
a data transfer circuit to accept data from the plurality of input ports and send the data to the plurality of output ports.

2. An integrated circuit comprising a network that includes a plurality of switches, a switch of the plurality of switches comprising:
a plurality of output ports including a first output port;
a plurality of input ports including a first input port that has a first bandwidth calculation circuit to calculate a first requested bandwidth for first packets received through the first input port to send through the first output port, and a second input port that has a second bandwidth calculation circuit to calculate a second requested bandwidth for second packets received through the second input port to send through the first output port;
a first bandwidth-weighted round-robin arbiter configured to, during a round-robin period, select the first input port for a first number of data transfers based on the first requested bandwidth, and to select the second input port for a second number of data transfers based on the second requested bandwidth; and
a first data transfer circuit to accept data from the plurality of input ports and send the data to the first output port.

3. The integrated circuit of claim 2, the first bandwidth calculation circuit further configured to:
examine first information included with the first packets to determine a first flow that includes a first subset of the first packets that have a first common origination agent;
determine a first flow bandwidth for the first flow; and
use the first flow bandwidth to calculate the first requested bandwidth.

4. The integrated circuit of claim 3, the first bandwidth calculation circuit further configured to:
examine the first information to determine that there are no other active flows, other than the first flow, in the first packets; and
use the first flow bandwidth as the first requested bandwidth.

5. The integrated circuit of claim 3, the first bandwidth calculation circuit configured to determine the first flow bandwidth by using a table to look up the first flow bandwidth for the first common origination agent.

6. The integrated circuit of claim 3, the first bandwidth calculation circuit further configured to:
examine the first information to determine a second flow that includes a second subset of the first packets that have a second common origination agent;
determine a second flow bandwidth for the second flow; and
use the first flow bandwidth and the second flow bandwidth to calculate the first requested bandwidth.

7. The integrated circuit of claim 6, the first bandwidth calculation circuit further configured to:
examine the first information to determine that there are no other active flows, other than the first flow and the second flow, in the first packets; and use a sum of the first flow bandwidth and the second flow bandwidth as the first requested bandwidth.

8. The integrated circuit of claim 6, the first bandwidth calculation circuit further configured to determine the first flow bandwidth and the second flow bandwidth by using a table to lookup the first flow bandwidth for the first common origination agent and to lookup the second flow bandwidth for the second common origination agent, wherein both the first flow bandwidth and the second flow bandwidth are integer values less than or equal to 255 and represent a requested number of transfers per round-robin period for the first output port.

9. The integrated circuit of claim 8, further comprising:
an array of configurable units, connected to the network, and configured to execute an application;
an array-level network connecting configurable units within the array of configurable units;
a tile agent coupled between the network and the array-level network;
a host agent coupled between an external data processing resource and the network;
a first memory agent coupled between first external memory and the network; and
a second memory agent coupled between second external memory and the network.

10. The integrated circuit of claim 9, wherein the first memory agent is the first common origination agent, the first external memory comprises double-data-rate (DDR) memory able to provide data to the network at a first data rate, the second memory agent is the second common origination agent, and the second external memory comprises high-bandwidth memory (HBM) memory able to provide data to the network at a second data rate, wherein a first ratio of the first flow bandwidth to the second flow bandwidth is between 50% and 150% of a second ratio of the first data rate to the second data rate.

11. The integrated circuit of claim 8, wherein the round-robin period includes a first period during which the first number of data transfers from the first input port to the first output port occur, a second period during which the second number of data transfers from the second input port to the first output port occur, and no other period during which data is transferred from either the first input port or the second input port to the first output port before starting a new round-robin period, wherein the first number of data transfers is equal to the first requested bandwidth, and the second number of data transfers is equal to the second requested bandwidth.

12. The integrated circuit of claim 2, the switch further comprising:
a second output port in the plurality of output ports;
a second bandwidth-weighted round-robin arbiter; and
a second data transfer circuit to accept data from the plurality of input ports and send the data to the second output port;
wherein the first bandwidth calculation circuit is further configured to calculate a third requested bandwidth for third packets received through the first input port to send through the second output port;
wherein the second bandwidth calculation circuit is further configured to calculate a fourth requested bandwidth for fourth packets received through the second input port to send through the second output port; and
wherein the second bandwidth-weighted round-robin arbiter is configured to, during a second round-robin period, select the first input port for a third number of data transfers based on the third requested bandwidth, and to select the second input port for a fourth number of data transfers based on the fourth requested bandwidth.

13. A method for use in a switch of in a mesh network, the method comprising:
receiving, from a first neighbor switch output or a first network agent at a first input of the switch, first packets that are to be forwarded to a first output of the switch;
calculating a first requested bandwidth by examining first information included with the first packets;
receiving, from a second neighbor switch output or a second network agent at a second input of the switch, second packets that are to be forwarded to the first output of the switch;
calculating a second requested bandwidth by examining second information included with the second packets;
transferring a first amount of data from the first input to the first output during a first round-robin period of a first arbiter, wherein the first amount of data is based on the first requested bandwidth; and
transferring a second amount of data from the second input to the first output during the first round-robin period, wherein the second amount of data is based on the second requested bandwidth.

14. The method of claim 13, wherein the first round-robin period includes a first period during which a first number of data transfers from the first input to the first output occur, a second period during which a second number of data transfers from the second input to the first output occur, and no other period during which data is transferred from either the first input or the second input to the first output before starting a new round-robin period, wherein the first number of data transfers is equal to the first requested bandwidth, and the second number of data transfers is equal to the second requested bandwidth.

15. The method of claim 13, further comprising:
determining, based on the first information, that the first packets include a first flow that includes a first subset of the first packets that have a first common origination agent;
determine a first flow bandwidth for the first flow; and
use the first flow bandwidth to calculate the first requested bandwidth.

16. The method of claim 15, further comprising:
determining, based on the first information, that there are no other active flows, other than the first flow, in the first packets; and using the first flow bandwidth as the first requested bandwidth.

17. The method of claim 15, further comprising using a table to look up the first flow bandwidth based on the first common origination agent.

18. The method of claim 15, further comprising:
determining, based on the first information, that the first packets include a second flow that includes a second subset of the first packets that have a second common origination agent;
determining a second flow bandwidth for the second flow; and
using the first flow bandwidth and the second flow bandwidth to calculate the first requested bandwidth.

19. The method of claim 18, further comprising:
determining, based on the first information, that there are no other active flows, other than the first flow and the second flow, in the first packets; and using a sum of the first flow bandwidth and the second flow bandwidth as the first requested bandwidth.

20. The method of claim 18, further comprising using a table to lookup the first flow bandwidth for the first common origination agent and to lookup the second flow bandwidth for the second common origination agent, wherein both the first flow bandwidth and the second flow bandwidth are integer values less than or equal to 255 and represent a requested number of transfers per round-robin period for the first output.
